(19) United States
(12) Patent Application Publication
(10) Pub. No.: US 2019/0026797 A1
(43) Pub. Date: Jan. 24, 2019

(54) Method and Billing Platform for Building Real Time Charge Aggregations

(71) Applicant: Telefonaktiebolaget LM Ericsson (publ), Stockholm (SE)

(72) Inventors: Ajit Raghavan, New Delhi (IN); Mikael Jakobsson, Hasslö (SE); Elisabeth Mueller, Mainz (DE); Manish Pawar, Gurgaon (IN)

(21) Appl. No.: 16/068,376

(22) PCT Filed: Jan. 19, 2016
(86) PCT No.: PCT/EP2016/051020

§ 371 Date: Jul. 6, 2018

(51) Int. Cl. G06Q 30/04

(52) U.S. Cl. CPC G06Q 30/04

(57) ABSTRACT

The disclosure relates to a method and a billing platform capable of building a real time aggregation without actually generating an invoice. In one embodiment, the method comprises steps of upon occurrence of an event to be charged, calculating (S102) a charge for the event; retrieving (S103) categorization attributes of charge information of the event; generating (S104) an identifier from the categorization attributes; and if an aggregation entity with the identifier does not exist in the billing platform, creating (S106) a new aggregation entity with the charge and the identifier, and storing the new aggregation entity in the billing platform. By storing a real time charge aggregation of an event in the platform rather than the event itself, a real time or continuous view of the upcoming invoice may be provided without actually generating the invoice.

### TECHNICAL FIELD

The disclosure relates to a technique of telecommunication management (TM). In particular, some embodiments of the disclosure relate to a method and a billing platform capable of building a real time charge aggregations without actually generating a bill.

### BACKGROUND

Unless otherwise indicated herein, the approaches described in this section are not prior art to the claims in this disclosure and are not admitted to be prior art by inclusion in this section.

In the age of data driven world, customers are demanding to have real time view of their account balances and financial liabilities from their service providers. Service providers like telecom service providers, utilities service providers, IPTV service providers etc., are traditionally used to send an invoice to the customers at regular intervals termed bill cycle e.g. monthly bill cycle. The bill (also termed invoice) contains the details of the financial charges break up under different financial headings e.g. total voice call charges, total rental charges, total energy consumption charges, total messaging charges etc., depending upon the service providers financial reporting requirements.

The problem with this “end of period” approach is that customers are not aware of their financial liabilities till they get a bill at the end of their bill cycle (typically at the end of the month). This might result in bill shocks which led to disputation with customers and potential write-offs & losses to service providers.

Also, service providers may want to be able to have a better support for accrual accounting. This requires a real-time view on unbilled charges categorized by products and services.

To get over these limitations, some of the service providers upgraded their billing platform to enable (near) real time charging for the customers. Charging refers to determining the charge applicable for a service consumption event (e.g. watching an on-demand movie, or making one international call etc.) based on the pricing rules configured and then adding those charges to the customer's unbilled account. This enabled customers to have a (near) real time view of their total unbilled amount. However, even in this scenario, the bill with financial charges break up is generated at the end of the bill cycle. The financial charges break up was visible only in the generated bill. It was not possible for the customer to have a real time or continuous view (i.e. near real time view depending upon when the service consumption event is received by the billing platform) of the upcoming bill with the financial charges break up without the actual invoice being generated.

Another drawback of this approach is the fact that at bill generation time, all charge events have to be retrieved from an event storage and the bill is calculated from this information. Thus each bill generation run results in a peak of resource consumption since the whole number crunching aspect of event aggregation has to be done at this point in time.

There have been few inventions on generating a bill (also termed invoice) in real time. But the search indicates that there has been no attempt to provide a real time or continuous view of the upcoming invoice without actually generating the bill.

The same problem is present for accrual accounting. Typically the financial accounting & reporting is also done at the end of the bill cycle period. There is no near real time financial reporting view available on product and service consumption. Thus the operator is forced to access the event detail storage (event history storage) and aggregate the data for these reporting needs in a very time consuming manner.

### SUMMARY

An object of the disclosure is to provide a method for use in a billing platform, which builds a real time charge aggregation without actually generating a bill, so that a customer can be provided with a real time or continuous view of the upcoming bill at any time within a bill cycle period.

According to a first aspect, there is provided a method for building a real time aggregation in a billing platform. Upon occurrence of an event to be charged, a charge for the event is calculated. Categorization attributes of charge information of the event is then retrieved. An identification is generated for the categorization attributes. If an aggregation entity with the identifier does not exist in the billing platform, a new financial aggregation entity with the charge and the identifier is created and stored in the billing platform. Thereby, a charge aggregation entity of an event (e.g., a service or a product) for a customer is generated and stored in the platform, which enables the platform to provide a real time or continuous view of upcoming invoice to customers.

In one embodiment, if an aggregation entity with the identifier already exists in the billing platform, the new aggregation entity is added to that one in the billing platform to get a sum which is used to update that one in the billing platform. In particular, the charge of the aggregation entity with the identifier is retrieved from the billing platform. The calculated charge is added with the retrieved charge to get a summed charge. The retrieved charge is updated with the summed charge in the aggregation entity. All this needs to be done as part of a single transaction to the billing platform, so as to ensure that the customer's account and financial charge aggregations for the current bill cycle are always in synchronization.

In one embodiment, the categorization attributes comprise one or more of customer identifier, contract identifier, Billing Account identifier, Billing Cycle Instance identifier, product identifier, service identifier, and price identifier.

In one embodiment, if a bill viewing request for a customer is received, one or more aggregation entities for that customer are retrieved from the billing platform, and the retrieved aggregation entities of that customer is displayed. In this way, the customer may be provided with a real time view of upcoming invoice at any time during a bill cycle.

In one embodiment, displaying the retrieved aggregation entities comprises determining a granular level of that customer; determining items to be displayed at the granular level; summarizing charges of aggregation entities of respective items; and displaying the charges under respective items. The aggregation entities are created on the most atomic charge break up level which is needed for legal and financial reasons as well as customer presentation needs. Since all the aggregation entities for a bill cycle instance are maintained at the atomic level, it is possible to do a summarization of these charges at a different higher aggregation level dynamically whenever the customer wants to see the current status of his bill anytime within the bill cycle period.

In one embodiment, if an invoice generation trigger is received, an invoice is generated to include the aggregation entities. The aggregation entities included in the invoice are moved to a different location in the billing platform. The aggregation entities may be used for invoice generation. Once they are supposed to be included in an invoice, the aggregation entities must not be touched any more. New aggregation entities are created for the next charge calculated.

In one embodiment, generating an invoice to include the aggregation entities comprises determining the Billing cycle of the invoice to be generated; and generating the invoice to include those aggregation entities whose Billing cycles match the Billing cycle of the invoice. The invoice may be correctly generated.

In one embodiment, calculating a charge for the event may comprise determining a charge originator, including a customer and a contact involved in the event.

In one embodiment, if the event is a service usage event, calculating a charge for the event may further comprise determining resource facing services on contract and associated configuration which match the event; determining customer facing services on contract and associated configuration which match the event; and determining a list of services to be charged based on the determinations.

In one embodiment, calculating a charge for the event may further comprise determining a list of candidate products to be charged for the event from the type of the event if no service to be charged is found, and otherwise determining a list of candidate products realizing the list of services to be charged; and sequencing the list of candidate products according to configuration and availability to determine a list of products to be charged.

In one embodiment, calculating a charge for the event may further comprise determining a list of candidate Billing Accounts for the event.

In one embodiment, calculating a charge for the event may further comprise getting price configuration from product offering definition and contracted prices; determining an applicable price from pricing matrix; determining a Billing Account for this price from a list of candidate Billing Accounts for the price; charging the event by using a list of products for the event and the list of candidate Billing Accounts; and enriching the charge with product identifier, price identifier, service identifier, and Billing Account identifier.

In one embodiment, calculating a charge for the event may further comprise determining the Bill Cycle for the event.

According to a second aspect, there is provided a billing platform capable of building a real time aggregation. The billing platform comprises a database configured to store aggregation entities; and a processor. The processor is configured to, upon occurrence of an event to be charged, calculate a charge for the event; retrieve categorization attributes of charge information of the event; generate an identifier from the categorization attributes; access the database to determine whether an aggregation entity with the identifier has already existed in the database; and if an aggregation entity with the identifier does not exist in the database, create a new aggregation entity with the charge and the identifier, and store the new aggregation entity in the database.

According to a third aspect, there is provided a computer program comprising computer readable codes, which when run on a processing unit, cause the processing unit to perform the methods according to the disclosure.

According to a fourth aspect, there is provided a tangible computer program product comprising a computer readable medium and a computer program according to the disclosure stored on the computer readable medium.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 illustrates a flowchart of a method for building a real time aggregation in a billing platform according to an embodiment of the disclosure.

FIG. 2 illustrates a flowchart of a method for providing a real time view of an upcoming invoice to a customer according to an embodiment of the disclosure.

FIG. 3 illustrates a flowchart of a method for generating an invoice of a customer according to an embodiment of the disclosure.

FIG. 4 shows two examples of bills of two different customers.

FIG. 5 shows an example of different aggregation levels at which the charges summarization can be reported on the bill.

FIG. 6 illustrates a flowchart of a method for determining a list of services to be charged for an event according to an embodiment of the disclosure.

FIG. 7 illustrates a flowchart of a method for determining the list of candidate products to be charged for an event according to an embodiment of the disclosure.

FIG. 8 illustrates a flowchart of a method for determining a list of candidate Billing Accounts to be charged for an event according to an embodiment of the disclosure.

FIG. 9 illustrates a flowchart of a method for determining a Billing Cycle of an event according to an embodiment of the disclosure.

FIG. 10 illustrates a block diagram of a billing platform according to another embodiment of the disclosure.

FIG. 11 is a schematic view of an arrangement which is applicable in the billing platform according to an embodiment of the disclosure.

### DETAILED DESCRIPTION OF EMBODIMENTS

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

There are some terminologies used frequently in this disclosure which are borrowed from/evolved from the TM Forum's Standard Information Framework (SID) to have a standardized definition for these terms. The Information Framework (SID) provides a reference model and common vocabulary for all the information required to implement Business Process Framework (eTOM) processes.

A short overview of these terminologies (a simplified view) is given below for quick reference:

a) Customer—Each customer is maintained in the service provider's billing platform as a separate Customer entity identified by a unique identifier.
b) Contract—Is a specific extension of the TM Forum SID entity agreement and represents an agreement between the customer and service provider for specific set of services. Each contract instance is associated with a unique identifier.
c) Price Type—The price type attribute attached to a price or a charge specifies if the price or charge represents a usage or recurring or one time price or charge. E.g. price for “x” minutes of a voice call or on-demand movie will have price type as “usage” within the catalog. Rental fees for a product or service will have price type as “recurring”. Any installation or termination fees associated with a service will have a price type as “one time”.
d) Product—Represents what is sold, leased or rented to Customers. In TM Forum SID model all the tangible or intangible goods & services which a service provider wants to offer to customers will be modeled as product offerings and made visible to customer via the product catalog. Product then represents an instance of the Product Offering sold/leased/rented to the customers. All the prices are specified as the product offering level. E.g. “Voice Gold” represents a Product offering available at a specific price which allows a customer to make use of voice call services of a mobile service provider.

Each Product instance is identified by a unique identifier.

Product instances are created under a contract in TM forum SID model.

e) Service—Services here refers to the customer facing services which a service provider is offering to the customer (via a product offering), e.g. “Local Voice Service”, “International Voice Service” etc.

Services are tightly bound to Products. A Product may be implemented through one or more Services which may utilize some Resources.

Another variant of the service is the resource facing service which usually represents the service or network resource view of the service. Usually a customer facing service is realized in the backend by a resource facing services. E.g. a local voice call customer facing service is realized in the charging platform via a CAMEL v2 online charging or CDR based offline charging resource facing service. The parameters received from the network for both these types of resource facing services are different. Resource facing service captures the services aspect from a network resource perspective.

Each service instance is identified by a unique identifier.

f) Price Identifier—This attribute represents the unique identifier of a Product Offering Price entity attached to a Product Offering. In TM Forum SID, the prices are specified via a Product Offering Price entity which is then associated with a Product Offering.
g) Bill Cycle—A Bill Cycle represents an instance of a recurrence period (say month) for which a bill is generated. E.g. for a customer who needs to be billed on 1st of every month, there would be a separate bill cycle instance created for each month and under a normal scenario a separate bill would be created for each of this bill cycle instance. All charges incurred by the customer in a given billing cycle would be included in the bill generated for that bill cycle instance.
h) Billing Account—A Billing account is an extension of SID customer account and acts as holder for all the charges of the customer which needs to be billed separately. A separate bill is generated per bill cycle period for each billing account a customer has. Usually customer would have only one billing account which means that they usually get only one regular bill for a bill cycle. Some customers would opt for multiple bills for different services e.g. a separate bill for mobility services and a separate bill for IPTV services etc. In such scenarios the customer would need to be associated with multiple billing accounts, one for each service where a separate bill is required. A rule for mapping the charges to correct billing account of the customer needs to be configured. Each billing account is identified by a unique account identifier.

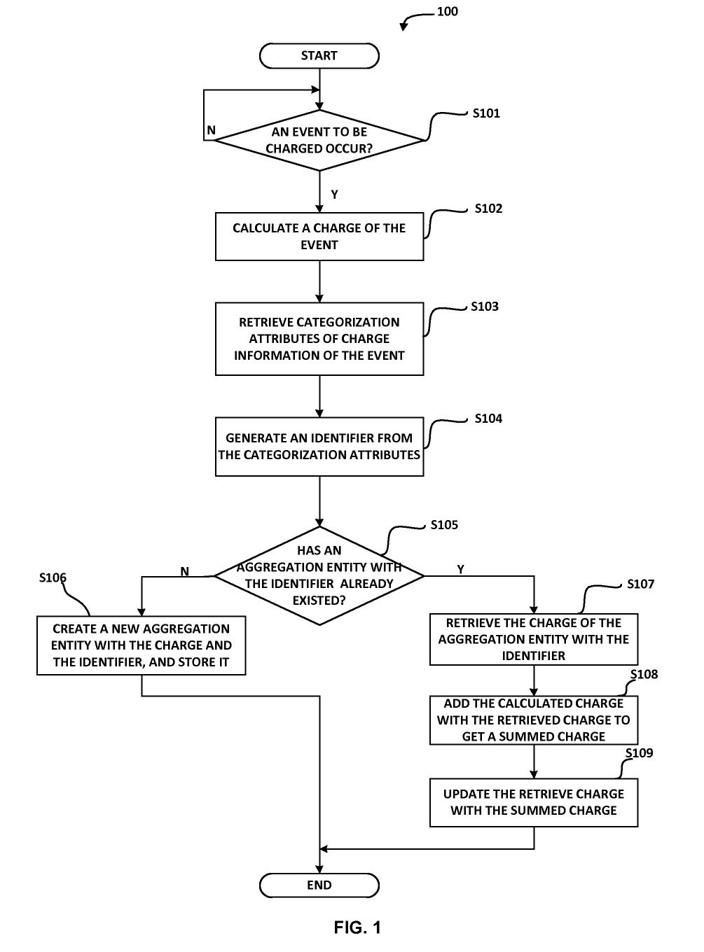

FIG. 1 illustrates a flowchart of a method 100 for building a real time aggregation in a billing platform according to an embodiment of the disclosure. As shown, it is monitored whether an event to be charged occurs at step S101. If such an event occurs, a charge for the event is calculated at step S102. Then at step S103, categorization attributes of charge information of the event is retrieved. In an embodiment, the categorization attributes of charge information comprise one or more of customer identifier, contract identifier, Billing Account identifier, Billing Cycle Instance identifier, product identifier, service identifier, and price identifier. In another embodiment, the categorization attributes of charge information may comprise different information, such as that defined in an industry other than the telecommunications industry, such as utilities or transport industry. At step S104, an identifier is generated from the categorization attributes. The identifier uniquely identifies the categorization attributes of the event. At step S105, it is determined whether an aggregation entity with the identifier exists in the billing platform. If the aggregation entity with the identifier does not exist in the billing platform, at step S106, a new aggregation entity with the charge and the identifier is created and stored in the billing platform. The method then ends.

If an aggregation entity with the identifier already exists in the billing platform, it goes to step S107, where the charge of the aggregation entity with the identifier is retrieved from the billing platform. Then at step S108, the calculated charge is added with the retrieved charge to get a summed charge, and at step S109, the retrieved charge is updated with the summed charge in the aggregation entity.

Categorization attributes of various events are predefined as required. By retrieving categorization attributes of charge information of the event and generating an identifier for the categorization attributes, the charges of the customer are aggregated at an appropriate aggregation level. For example, if the categorization attributes that identify an event are defined to include customer identifier, contract identifier, Billing Account identifier, Billing Cycle Instance identifier, product identifier, service identifier and price type, the charge of an event of a customer can be aggregated at a level of “Customer identifier+contract identifier+billing account identifier+Billing Cycle Instance identifier+product identifier+service identifier+price type,” which is identified by the generated identifier. Since all the charge aggregations are maintained at an appropriate, e.g., most atomic, aggregation level, it is possible to do a summarization of these charges at a different higher aggregation level dynamically whenever the customer wants to see the status of his bill anytime within the bill cycle period. For example, the charge may be summarized at a higher aggregation level “Customer identifier+contract identifier+billing account identifier+price type” by adding up all the charges of the lower aggregation level having keys starting with the above higher level aggregation key.

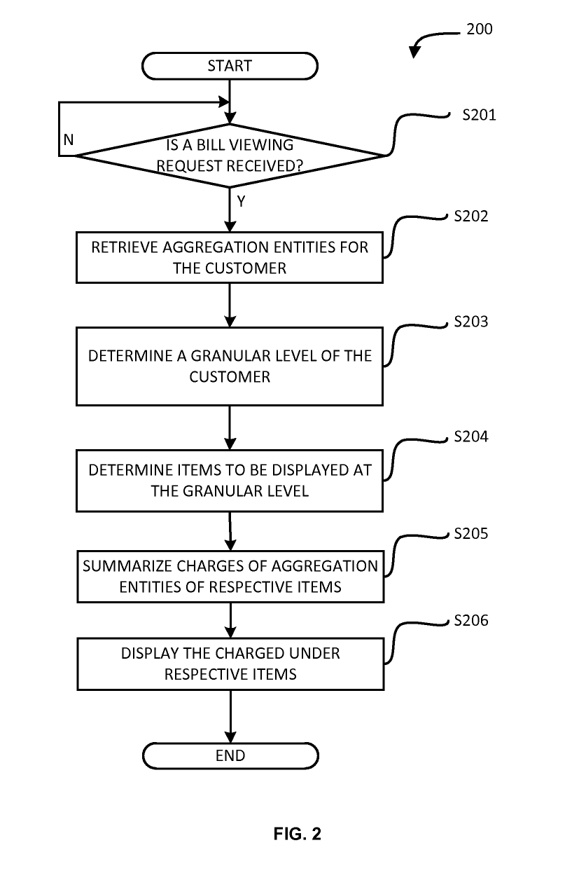

FIG. 2 illustrates a flowchart of a method 200 for providing a real time view of an upcoming invoice to a customer according to an embodiment of the disclosure. As shown, it is monitored whether a bill viewing request is received at step S201. The request may come from the customer, or be issued periodically. In response to a bill viewing request, one or more aggregation entities for that customer are retrieved from the billing platform at step S202. That is, aggregations entities with “customer identifier” of that customer are retrieved. The granular level of that customer is determined at step S203. The items to be displayed at the granular level are then determined at step S204. Then charges of aggregation entities of that customer are summarized at the respective items at step S205. The charges are displayed under respective items at step S206. The method then ends.

The method allows customers to always have a real time or continuous view of their upcoming invoice and take informed decision to alter their service consumption to avoid huge bills (bill shocks). This also enables a better customer satisfaction resulting in lower customer complaint for the service provider. This also enables to increase the confidence of the customer on the service provider resulting them to consume more services which means additional revenue for the service provider.

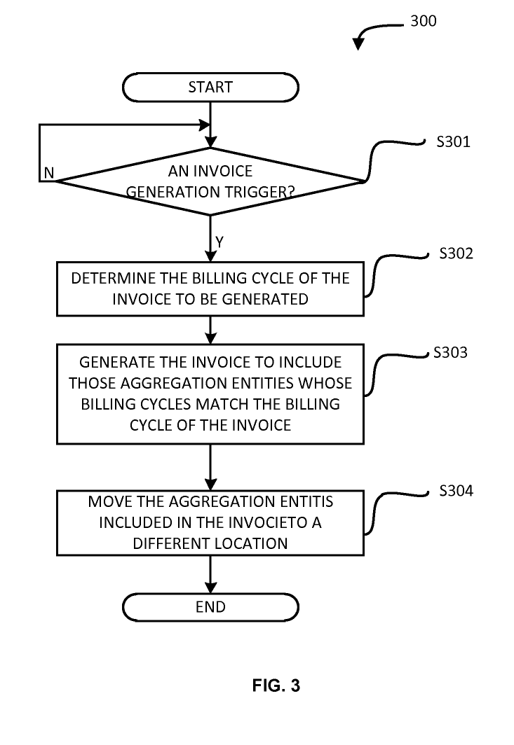

The aggregation entities stored can be used for invoice generation. FIG. 3 illustrates a flowchart of a method 300 for generating an invoice of a customer according to an embodiment of the disclosure. As shown, it is monitored whether an invoice generation trigger is received at step S301. If an invoice generation trigger is received, the Billing Cycle of the invoice to be generated is determined at step S302. Then the invoice is generated at step S303. The invoice includes those aggregation entities whose billing cycles match the Billing Cycle of the invoice. The aggregation entities must not be touched any more once they are supposed to be included in an invoice. Thus, at step S304, the aggregation entities included in the invoice are moved to a different location in the platform, or to a different storage. The method then ends.

The invoice may also be reported at different charge aggregation levels for different customer, or under different requirements. The method as shown in FIG. 2 is applicable in the invoice generation process. That is, before displaying the aggregation entities to be included in the invoice, the aggregation entities are summarized at the granular level dedicated to the customer.

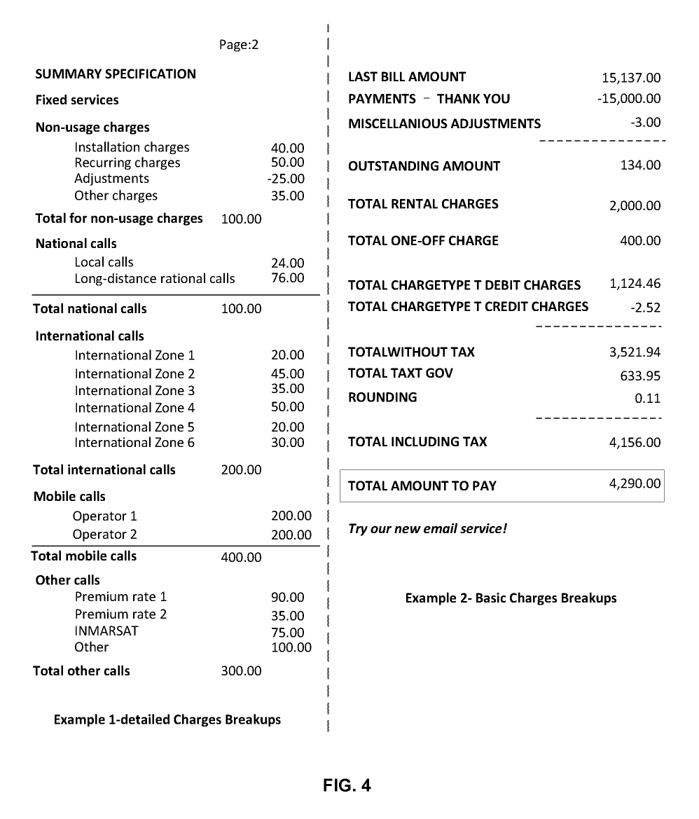

FIG. 4 shows two examples of bills of two different customers, where the charges are reported at different charge aggregation levels. In the example 1 the charges are reported at a much more granular level than what is reported in example 2.

The categorization attributes/items and the aggregation entities (summary values) may be used when presenting the invoice. In the simplest case an aggregation entity corresponds to an invoice position and the categorization attributes/items are used as “description” of the invoice position, as shown in FIG. 4.

The aggregation level chosen for a customer may be the decision of the service provider. For some customers with basic subscription, the charge break up, i.e. the aggregation level is reported in the bill at a very high level, e.g. total service consumption charges, total rental charges, total miscellaneous charges etc. For some premium customers, the charge break up is reported at much more granular level, e.g. total voice call usage charges, total premium movie usage charges, total peak time energy consumption charges etc. The method according to the disclosure allows the charges to be aggregated on a real time/continuous basis under different categories and still have a flexibility to display the bill view/invoice under a totally different aggregation level.

What shall be noted is that the categorization of the charges has to fulfil legal requirements when it comes to taxation, financial requirements when it comes to accounting and also business requirements when it comes to presentation of the aggregated charges to the customers, online or on invoice documents. FIG. 4 also shows the taxes along with the charges in example 2.

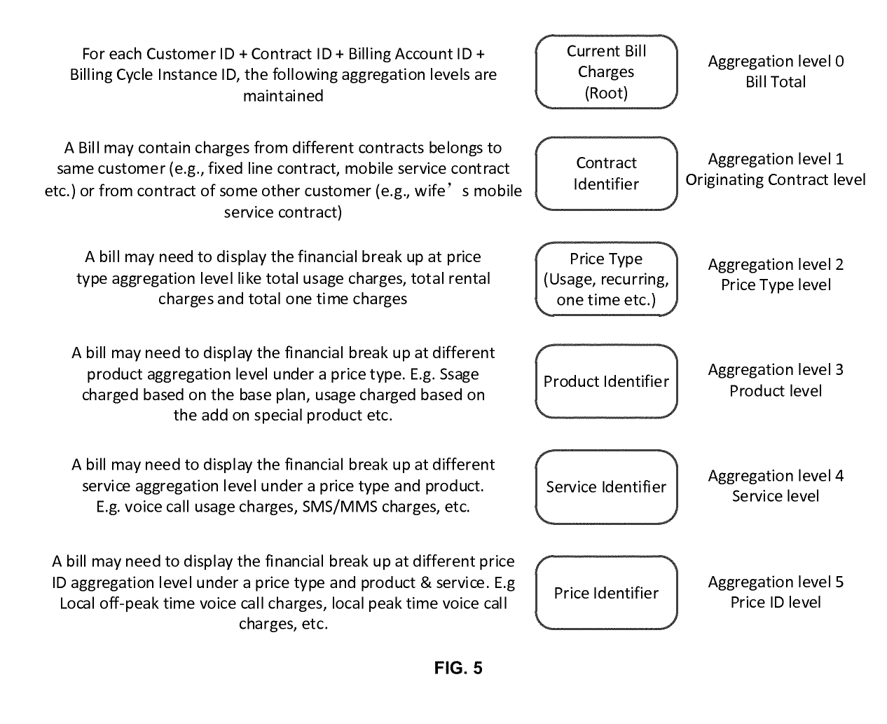

FIG. 5 shows an example of different aggregation levels at which the charges summarization can be reported on the bill. What shall be noted is that for rental (recurring) charges as well as the one time charges, the aggregation category keys as well as the aggregation levels may be different.

The continuous aggregation will allow a much faster bill generation because the resources needed to calculate the aggregation entities are spread over the whole period instead of concentrating them at invoice generation point of time.

The pre-categorized aggregation entities also can be used as input to accrual accounting. The Operator will be able to speed up accrual reporting by accessing the prepared aggregation entities instead of event storage.

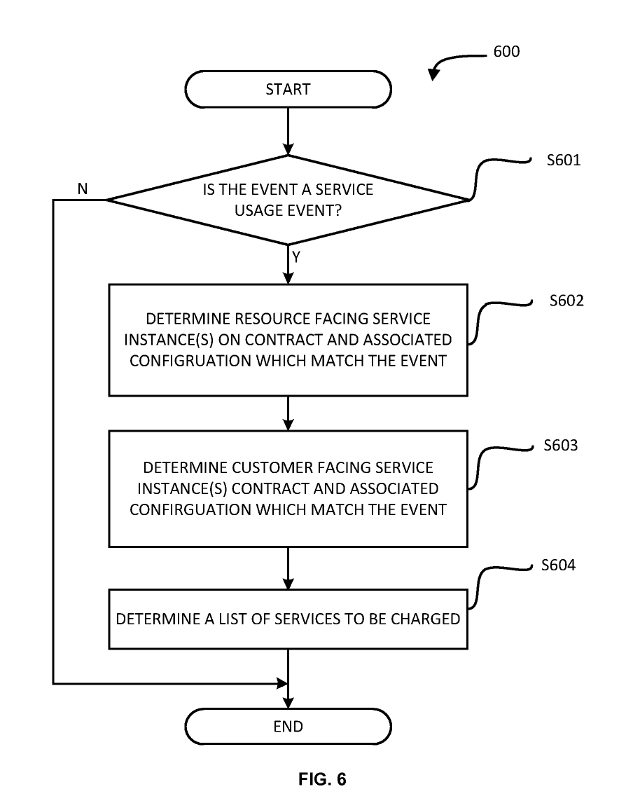

In order to charge an event, the charge originator of the event, i.e., customer and contract involved in the event shall be determined. The settings on the contract of the charge originator are used for product and price determination. The list of services to be charged is also determined. FIG. 6 illustrates a flowchart of a method 600 for determining a list of services to be charged for an event according to an embodiment of the disclosure. Upon an occurrence of an event, it is determined whether the event is a service usage event at step S601. If the event is a service usage event, resource facing service instance(s) on contract and associated configuration which match the event are determined at step S602. Then customer facing service instance(s) on contract and associated configuration which match the event are determined at step S603. Then at step S604, a list of services to be charged are determined based on the determinations of steps S602 and S603. The method then ends. If the event is determined not to be a service usage event at step S601, the method ends. The billing platform may receive different types of events (service usage events like call events, messaging events etc., scheduler events say for charging rental fees, one-time events say for charging installation or activation fees etc.). Based on the type of the event received, the billing platform needs to trigger the right set of actions (e.g. service usage charging, rental fees charging, activation fees charging etc.). FIG. 6 represents the flow from a service usage perspective.

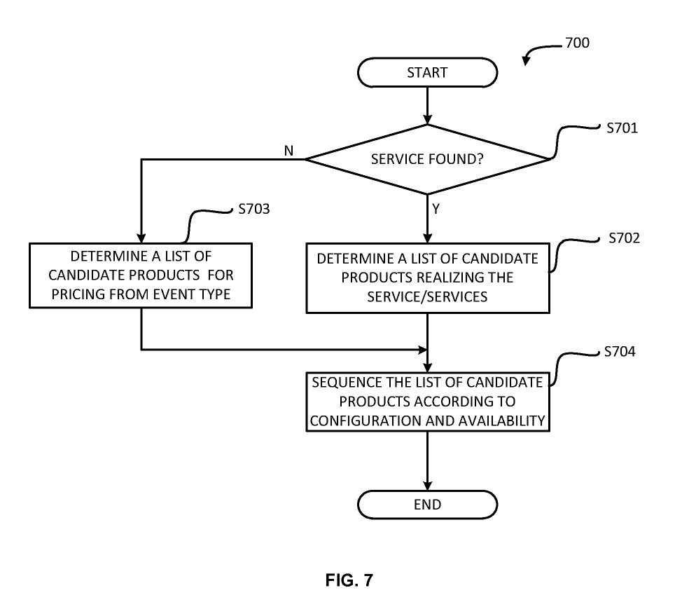

In order to charge an event, the list of products to be charged for the event is determined. FIG. 7 illustrates a flowchart of a method 700 for determining a list of products to be charged for an event according to an embodiment of the disclosure. At step S701, it is determined whether a service to be charged is found for the event. If a service or a list of services to be charged is found, a list of candidate products realizing the service/the list of services to be charged is determined at step S702. If no service to be charged is found, a list of candidate products to be charged for the event is determined from the type of the event at step S703. A customer may have multiple candidate products (e.g. Base Tariff Plan, Discounted Rate Tariff Plans, promotional Tariff offers) applicable for charging of an event. The billing platform needs to sort the candidate products based on configured rules to determine which product needs to be used to determine the pricing for the event. For example, the customer has a Base Rate plan which charges voice calls at $x per min. The customer takes on an add-on plan which gives him a discounted rate of $y per min valid for one week. The customer is also given a promotional offer valid for one day as part of a campaign which gives a 50% discount on applicable rate (either $x or $y depending on date/time a call is made). In this scenario the billing platform needs to sort the above 3 products in a priority order and select the product(s) for which the call needs to be charged. Accordingly, at step S704, the determined list of candidate products are sequenced according to configuration and availability, so as to determine a list of products to be charged. The method then ends.

In order to charge an event, a list of candidate Billing Accounts for the event shall be determined. The customer may want to have separate bills for different products or services (e.g. different bill for all Voice call charges and different bill for all Messaging & Data charges). Another example could be that the customer's employer pays (i.e. a separate Billing account of employer) for all working time local calls and the customer needs to pay for all non-working time calls. So before a charge is calculated, it is necessary to identify which Billing Account the charge needs to be applied to.

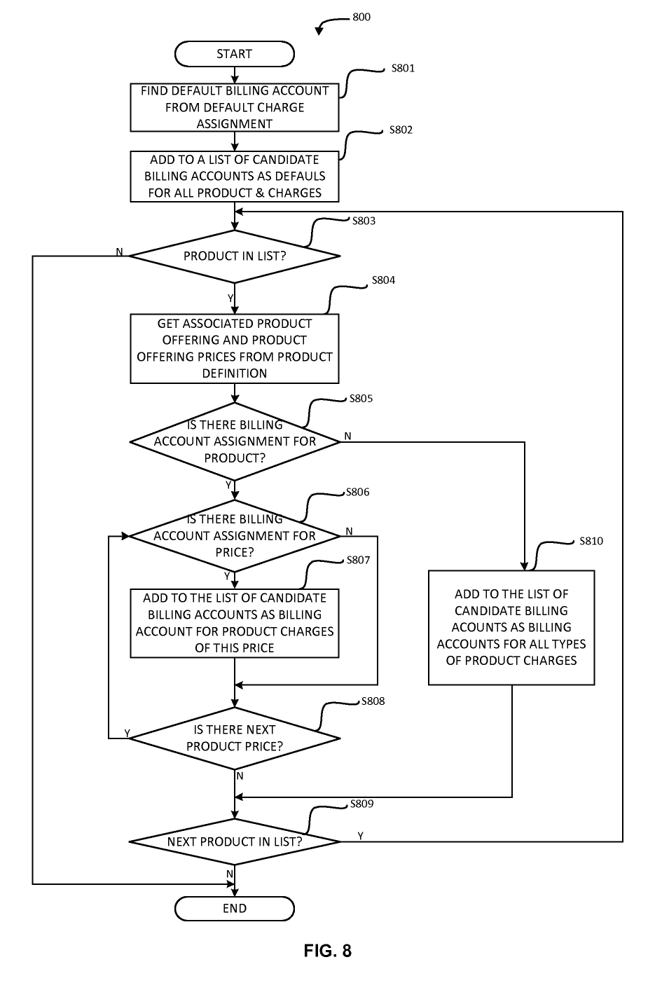

FIG. 8 illustrates a flowchart of a method 800 for determining a list of candidate Billing Accounts to be charged for an event according to an embodiment of the disclosure. At step S801, default Billing Accounts are found from contract from default charge assignment. The found Billing Accounts are then added to a list of candidate Billing Accounts as default for all products & charges at step S802. Then it is determined whether there is a product in list at step S803. If there are no more products, the method ends. If there is a product, associated product offering and product offering prices are obtained from product definition at step S804. It is determined whether there is a Billing Account Assignment for the product at step S805. If there is no Billing Account Assignment for the product, it is determined whether there is a Billing Account Assignment for the product price at step S806. If there is a Billing Account Assignment for the product price, the Billing Accounts defined in the Billing Account Assignment are added to the list of candidate Billing Account as the Billing Accounts for product charges of the price at step S807. If there is no Billing Account Assignment for the product price, it is determined whether there is a next product price at step S808. If there is a next product price, the method turns to step S806. If there is no more product price, the method proceeds to step S809, where it is determined whether there is a next product in the list. If there are no more products, the method ends. If there is a next product, the method turns to step S803. If it is determined there is a Billing Account Assignment for the product in step S805, the method proceeds to step S810, where the Billing Accounts defined in the Billing Account Assignment are added to the list of candidate Billing Accounts as Billing Accounts for all types of product charges. If it is determined that there is a next product price at step S808, the method turns to step S806.

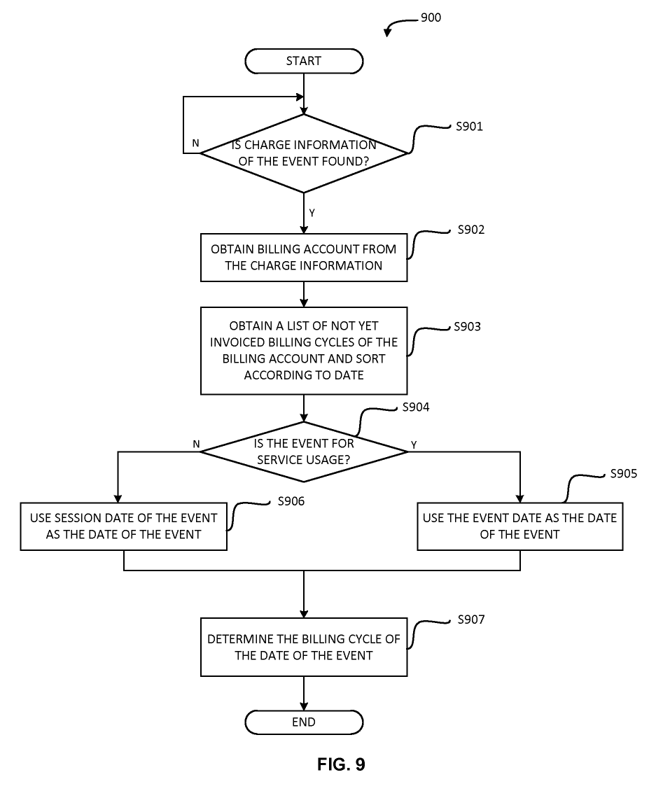

FIG. 9 illustrates a flowchart of a method 900 for determining a Billing Cycle of an event according to an embodiment of the disclosure. As shown in the figure, upon an occurrence of an event, it is determined whether there is charge information of the event found at step S901. If there is, a Billing Account is obtained from the charge information at step S902, and a list of not-yet invoiced Billing Cycles of the Billing Account is obtained and sorted according to the date at step S903. At step S904, it is determined whether the event is for service usage. If yes, the method proceeds to step S905 where the session date of the event is used as the date of the event. If the event is not for service usage, the method proceeds to step S906, where the event date is used as the date of the event. The method then proceeds to step S907, where the Billing Cycle of the date of the event is determined. Then the method ends.

Calculation of a charge of an event may comprise getting price configuration from product offering definition and contracted prices, and determining an applicable price from pricing matrix. Then a Billing Account for the price is determined from a list of candidate Billing Accounts for the price. The event is charged by using a list of products for the event and the list of candidate Billing Accounts. The charge is then enriched with categorization attributes of charge information of the event, such as product identifier, price identifier, service identifier, Billing Account identifier, and others.

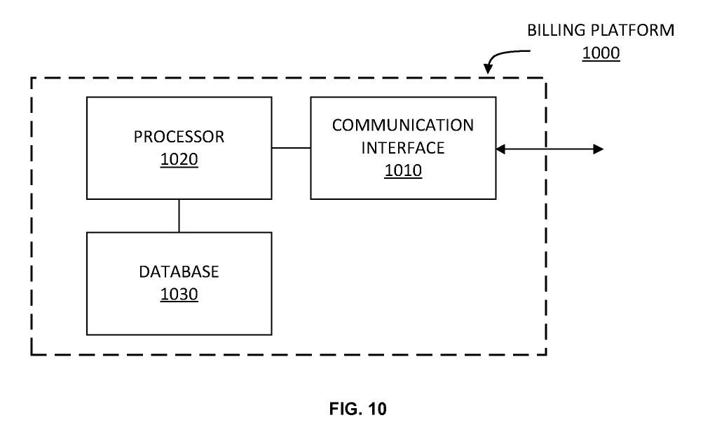

The methods and procedures according to the disclosure described above may be performed by any suitable components or other means capable of performing the corresponding functions of the methods and procedures. For example, the methods and procedures may be performed at any billing platform illustrated in FIG. 10, or at a different server or site that communicates with the billing platform.

FIG. 10 illustrates a block diagram of a billing platform 1000 according to another embodiment of the disclosure. As shown, the billing platform 1000 comprises a communication interface 1010 configured to communicate with other devices, a processor 1020, and a database 1030 having stored therein aggregation entities. In an embodiment, the processor 1020 is configured to, upon occurrence of an event to be charged, calculate a charge for the event, and retrieve categorization attributes of charge information of the event. Then the processor 1020 generates an identifier from the categorization attributes and accesses the database to determine whether an aggregation entity with the identifier has already existed in the database. If an aggregation entity with the identifier does not exist in the database, the processor 1020 creates a new aggregation entity with the charge and the identifier, and stores the new aggregation entity in the database.

In an embodiment, as shown in FIG. 1, especially steps S107˜S109, if an aggregation entity with the identifier already exists in the billing platform, the processor is configured to retrieve the charge of the aggregation entity with the identifier from the database, add the calculated charge with the retrieved charge to get a summed charge, and update the retrieved charge with the summed charge in the aggregation entity.

In an embodiment, the database is provisioned with a table mapping various events to categorization attributes of charge information, and the categorization attributes comprise one or more of customer identifier, contract identifier, Billing Account identifier, Billing Cycle Instance identifier, product identifier, service identifier, and price identifier. Thereby when an event occurs, the categorization attributes of charge information for the event can be retrieved from the billing platform. In another embodiment, the table may be stored in a different location in the billing platform, or even at a different device than the billing platform and may be communicated to the database when needed.

The communication interface 1010 is configured to receive an input and output data. The communication interface 1010 may be any kind of I/O interface that is applicable to the billing platform. For example, the communication interface 1010 may be a wired line connected to outside, or a wireless interface that communicates with other devices wirelessly. When a bill viewing request for a customer is received via the communication interface, the processor 1020 is configured to retrieve from the database one or more aggregation entities for that customer, and output the retrieved aggregation entities via the communication interface, so that the customer can view the upcoming invoice.

The aggregation entities in the database may be stored in a most atomic aggregation level so that it is possible to do a summarization of the charges at a different higher aggregation level dynamically whenever a customer wants to see the status of his bill. In such case, the processor 1020 is configured to, prior to outputting the retrieved aggregation entities of the customer, determine a granular level of that customer, determine items to be displayed at the granular level, summarize charges of aggregation entities of respective items, and output the charges of aggregation entities of respective items along with the description of the items.

The aggregation entities in the database can be used for invoice generation. When an invoice generation request is received at the communication interface of the platform, the processor 1020 is configured to generate an invoice to include the aggregation entities, and move the aggregation entities included in the invoice in the database to be isolated from the part of the database in which the aggregation entities are stored. There might be a time lag between the billing cycle end and the actual time the invoice for that cycle is generated. For example, the invoice for January may be created few hours or days behind the end of January, i.e., at the first days of Febraury, based on the scheduler configuration. Customers might use services during the time from the end of January to the time the invoice for January is created. There is a need to ensure that all February charges are aggregated separately from January charges when creating the January invoice at the first days of February. The processor 102 is thus configured to, in generating the invoice, determine the Billing cycle of the invoice to be generated and generate the invoice to include those aggregation entities whose Billing Cycles match the Billing cycle of the invoice.

It should be noted that the billing platform 1000 as shown in FIG. 10 may include more or fewer elements than shown, in various arrangements, and each component may be implemented in hardware, software or combination thereof.

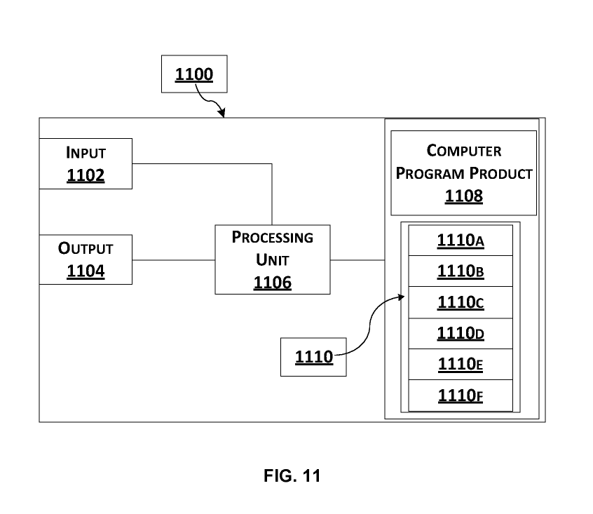

FIG. 11 is a schematic view of an arrangement 1100 which may be used in the billing platform. Comprised in the arrangement 1100 are here a processing unit or processor 1106, e.g., with a Digital Signal Processor (DSP). The processing unit 1106 may be a single unit or a plurality of units to perform different actions of the methods and procedures described herein. The arrangement 1100 may also comprise an input unit 1102 for receiving signals from other devices, and an output unit 1104 for providing signal(s) to other devices. The input unit and the output unit may be arranged as an integrated entity or as illustrated in the example of FIG. 11.

Furthermore, the arrangement 1100 comprises at least one computer program product 1108 in the form of a non-volatile or volatile memory, e.g., an Electrically Erasable Programmable Read-Only Memory (EEPROM), a flash memory and a hard drive. The computer program product 1108 comprises a computer program 1110, which comprises code/computer readable instructions, which when executed by the processing unit 1106 in the arrangement 1100, cause the arrangement 1100 and/or the billing platform 1000 in which it is comprised to perform the actions, e.g., of the procedures described earlier in conjunction with FIGS. 1-3 and 6-9.

The computer program 1110 may be configured as a computer program code structured in computer program modules 1110A-1110C.

In an exemplifying embodiment, the code in the computer program of the arrangement 1100 includes a calculating module 1110A for calculating a charge of an event. The code in the computer program 1110 may further include a retrieving module 11108 for retrieving categorization attributes of charge information of the event. The code in the computer program 1110 may further include a generating module 1110C for generating an identifier from the categorization attributes. The code in the computer program 1110 may further include a creating module 1110D for creating a new aggregation entity with the charge and the identifier, and storing the new aggregation entity in the arrangement 1100 or in the billing platform 1000 in which it is comprised.

According to an embodiment, the code in the computer program 1110 may further include an updating module 1110E for retrieving the charge of the aggregation entity with the identifier from the arrangement, adding the calculated charge with the retrieved charge to get a summed charge, and updating the retrieved charge with the summed charge.

According to an embodiment, the code in the computer program 1110 may further include a bill viewing module 1110F for, in response to a bill viewing request for a customer, retrieving one or more aggregation entities for that customer and outputting the retrieved aggregation entities via the output unit so that the customer may view the upcoming invoice. In another embodiment, before outputting the retrieved aggregation entities, the bill viewing module 1110F may determine a granular level of that customer, determine items to be displayed at the granular level, summarize charges of aggregation entities of respective items, and output the charges along with respective items of the charges.

The foregoing description of implementations use the terminologies borrowed from the TM Forum's SID to illustrate the processes and the blocks. It can be recognized that the processes and blocks are not limited to the TM, and applicable to other industries, such as utilities or transport industry where it is needed to bill a huge amount of product and service usage transactions and onetime as well as periodically calculated charges.

The foregoing description of implementations provides illustration and description, but is not intended to be exhaustive or to limit the disclosure to the precise form disclosed. Modifications and variations are possible in light of the above teachings, or may be acquired from practice of the disclosure. For example, while blocks have been described with regard to FIGS. 1-3 and 6-9 in a specific order, the order of the blocks may be modified in other implementations consistent with the principles of the disclosure. Further, non-dependent blocks may be performed in parallel.

Aspects of the disclosure may also be implemented in methods and/or computer program products. Accordingly, the disclosure may be embodied in hardware and/or in hardware/software (including firmware, resident software, microcode, etc.). Furthermore, the disclosure may take the form of a computer program product on a computer-usable or computer-readable storage medium having computer-usable or computer-readable program code embodied in the medium for use by or in connection with an instruction execution system. The actual software code or specialized control hardware used to implement embodiments described herein is not limiting of the disclosure. Thus, the operation and behaviour of the aspects were described without reference to the specific software code—it being understood that those skilled in the art will be able to design software and control hardware to implement the aspects based on the description herein.

Furthermore, certain portions of the disclosure may be implemented as “logic” that performs one or more functions. This logic may include hardware, such as an application specific integrated circuit or field programmable gate array or a combination of hardware and software.

It should be emphasized that the term “comprises/comprising” when used in this specification is taken to specify the presence of stated features, integers, steps, components or groups but does not preclude the presence or addition of one or more other features, integers, steps, components or groups thereof.

No element, act, or instruction used in the disclosure should be construed as critical or essential to the disclosure unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

The foregoing description gives only the embodiments of the present disclosure and is not intended to limit the present disclosure in any way. Thus, any modification, substitution, improvement or like made within the spirit and principle of the present disclosure should be encompassed by the scope of the present disclosure.

1-22. (canceled)

23. A method for building a real time aggregation in a billing platform, comprising:
upon occurrence of an event to be charged, calculating a charge for the event;
retrieving categorization attributes of charge information of the event;
generating an identifier from the categorization attributes; and
in response to determining that an aggregation entity with the identifier does not exist in the billing platform, creating a new aggregation entity with the calculated charge and the identifier, and storing the new aggregation entity in the billing platform.

24. The method of claim 23, further comprising, in response to determining that an aggregation entity with the identifier already exists in the billing platform:
retrieving the charge of the aggregation entity with the identifier from the billing platform;
adding the calculated charge with the retrieved charge to get a summed charge; and
updating the retrieved charge with the summed charge in the aggregation entity.

25. The method of claim 23, wherein the categorization attributes comprise one or more of: customer identifier, contract identifier, Billing Account identifier, Billing Cycle Instance identifier, product identifier, service identifier, and price identifier.

26. The method of claim 25, further comprising:
in response to a bill viewing request for a customer, retrieving one or more aggregation entities for the customer from the billing platform; and
displaying the retrieved aggregation entities of the customer.

27. The method of claim 26, wherein displaying the retrieved aggregation entities further comprises:
determining a granular level of the customer;
determining items to be displayed at the granular level;
summarizing charges of aggregation entities of respective items; and
displaying the charges under the respective items.

28. The method of claim 23, further comprising:
in response to an invoice generation trigger, generating an invoice to include aggregation entities from the billing platform; and
moving the aggregation entities included in the invoice to a different location in the billing platform.

29. The method of claim 28, wherein generating an invoice to include the aggregation entities further comprises:
determining a Billing cycle of the invoice to be generated; and
generating the invoice to include aggregation entities whose Billing cycles match the Billing cycle of the invoice.

30. The method of claim 23, wherein calculating a charge for the event further comprises determining a charge originator, including a customer and a contact involved in the event.

31. The method of claim 30, wherein calculating a charge for the event further comprises, if the event is a service usage event:
determining resource facing services on contract and associated configuration that match the event;
determining customer facing services on contract and associated configuration that match the event; and
determining a list of services to be charged based on the determinations.

32. The method of claim 31, wherein calculating a charge for the event further comprises:
determining a list of candidate products to be charged for the event from a type of the event if no service to be charged is found, and otherwise determining a list of candidate products realizing the list of services to be charged; and
sequencing the list of candidate products according to configuration and availability to determine a list of products to be charged.

33. The method of claim 32, wherein calculating a charge for the event further comprises determining a list of candidate Billing Accounts for the event.

34. The method of claim 33, wherein calculating a charge for the event further comprises:
getting a price configuration from a product offering definition and contracted prices;
determining an applicable price from a pricing matrix;
determining a Billing Account for the price from a list of candidate Billing Accounts for the price;
charging the event by using the list of products for the event and the list of candidate Billing Accounts; and
enriching the charge with a product identifier, a price identifier, a service identifier, and a Billing Account identifier.

35. The method of claim 34, wherein calculating a charge for the event further comprises determining a Bill Cycle for the event.

36. A billing platform capable of building a real time aggregation, comprising:
a database configured to store aggregation entities; and
a processor configured to:
upon occurrence of an event to be charged, calculate a charge for the event;
retrieve categorization attributes of charge information of the event;
generate an identifier from the categorization attributes;
access the database to determine whether an aggregation entity with the identifier has already existed in the database; and
in response to determining that an aggregation entity with the identifier does not exist in the database, create a new aggregation entity with the calculated charge and the identifier, and store the new aggregation entity in the database.

37. The billing platform of claim 36, wherein the processor is further configured to, in response to determining that an aggregation entity with the identifier has already existed in the database:
retrieve the charge of the aggregation entity with the identifier from the database;
add the calculated charge with the retrieved charge to get a summed charge; and
update the retrieved charge with the summed charge in the aggregation entity.

38. The billing platform of claim 36, wherein the database is provisioned with a table mapping various events to categorization attributes of charge information, and the categorization attributes comprise one or more of: customer identifier, contract identifier, Billing Account identifier, Billing Cycle Instance identifier, product identifier, service identifier, and price identifier.

39. The billing platform of claim 38, wherein the billing platform further comprises an interface for receiving an input and outputting data, and wherein the processor is further configured to:
in response to a bill viewing request for a customer received at the interface, retrieve one or more aggregation entities for the customer from the database; and
output the retrieved aggregation entities of the customer via the interface to be displayed to the customer.

40. The billing platform of claim 39, wherein prior to outputting the retrieved aggregation entities of the customer, the processor is further configured to:
determine a granular level of the customer;
determine items to be displayed at the granular level;
summarize charges of aggregation entities of respective items; and
output the charge of aggregation entities of respective items along with a description of the respective items.

41. The billing platform of claim 36, wherein the processor is further configured to:
in response to an invoice generation trigger received at an interface of the billing platform, generate an invoice to include aggregation entities from the billing platform; and
move the aggregation entities included in the invoice in the database to be isolated from a part of the database in which the aggregation entities are stored.

42. The billing platform of claim 41, wherein the processor is further configured to:
determine a Billing cycle of the invoice to be generated; and
generate the invoice to include aggregation entities whose Billing cycles match the Billing cycle of the invoice.
